(19) United States
(12) Patent Application Publication
(10) Pub. No.: US 2024/0094962 A1
(43) Pub. Date: Mar. 21, 2024

(54) IMAGE PROCESSING DEVICE SYSTEM, IMAGE CODE OUTPUT METHOD, A COMPUTER-READABLE NON-TRANSITORY RECORDING MEDIUM

(71) Applicant: SHARP KABUSHIKI KAISHA, Sakai City (JP)

(72) Inventor: Mikihisa NAGASHIMA, Sakai City (JP)

(21) Appl. No.: 18/236,941

(22) Filed: Aug. 22, 2023

(30) Foreign Application Priority Data
Sep. 16, 2022 (JP) 2022-148128

(51) Int. Cl. G06F 3/12

(52) U.S. Cl. CPC G06F 3/1242; G06F 3/1204; G06F 3/1256; G06F 3/1265

(57) ABSTRACT

An image processing device system includes an image processing device and a portable terminal. The image processing device includes an outputter that outputs, to an external destination, operation settings information about operation settings configured through an operation by a user, an image code reader that reads an image code, an image code analyzer that analyzes the image code and generates the operation settings information, and a configurator that applies operation settings based on the operation settings information. The portable terminal includes a terminal inputter to which the operation settings information is input, a terminal operation settings editor that edits the operation settings information in accordance with an operation by the user and generates a new instance of the operation settings information, a terminal image code generator that generates an image code based on the new instance, and a terminal image code outputter that outputs the image code.

### TECHNICAL FIELD

The present disclosure relates to an image processing system including a portable terminal such as a mobile phone and an image processing device, an image code output method, and a computer program.

### BACKGROUND ART

An image forming device such as a copying machine, a facsimile machine, a printer, or a multifunction peripheral may be installed in an environment such as a convenience store where a large number of unspecified users use the image forming device. In such a case, since some of the users do not know how to operate the image forming device, an image forming device is generally installed that is, for example, interactive and for which settings are configured through a sequential operation. Specifically, there is installed an image forming device that prompts a user to, when copying, sequentially configure settings such as selection of color copy or monochromatic copy, selection of paper size, whether enlargement/reduction is necessary, and the number of copies. Thus, even a user who does not know how to operate the image forming device can perform copying or the like without making an error in operation.

However, there is a problem that such an interactive image forming device is tedious for a user who is accustomed to this operation. Further, a user who often uses the same settings when using the image forming device needs to apply the same settings every time, causing the operation to be tedious. For example, many users are believed to use an image forming device to make monochromatic copies on A4 paper at the same magnification each time, but there is the problem that such users also have to sequentially configure these tedious settings such as making monochromatic copies on A4 paper at the same size every time when using the image forming device. This means that the image forming device is occupied whenever the configuration operation is performed. In other words, the image forming device cannot perform printing, copying, or the like in a state where the configuration operation is performed on the image forming device. Therefore, there is also a problem that the image forming device has poor operation efficiency.

Therefore, various proposals have been made to solve such problems. For example, there is disclosed an image forming device capable of displaying an image code based on settings contents configured by a user and reading an image of the image code to apply the settings without operation by the user. The user captures and stores the image code displayed when using the image forming device through a smartphone or the like, displays the image code stored on the smartphone on a screen of the smartphone when using the image forming device the next time, and holds the smartphone over a reader of the image forming device to cause the reader to read the image code. As a result, according to the image forming device, the settings corresponding to the read image code (the settings contents previously configured by the user) are automatically applied. Therefore, when the user operates the image forming device with the same settings, the user can easily configure the settings without performing an operation of sequentially inputting the settings every time, omitting any tedious operations. As a result, it is not necessary to manually input the settings of the image forming device whenever using the image forming device, and the above-described problems can be solved.

### SUMMARY

### Technical Problem

As described above, an advantageous effect is obtained of being able to reduce a burden on the user when operating the image forming device. An advantageous effect is also achieved of being able to improve operation efficiency of the image forming device, since an operation time of the image forming device can be shortened.

However, the above-described advantageous effects are achieved in a case where the operation of the image forming device is performed with the same settings as the previous operation, but in a case where the settings are configured differently from the previous time, it is necessary to perform the tedious operation of sequentially applying the settings from the beginning to the image forming device, which does not improve the operation efficiency of the image forming device. Therefore, there is a demand for an image forming device capable of further reducing the burden on the user.

The present disclosure has been made in view of the above-described circumstances, and has an object to provide an image processing device system capable of reducing an operation burden on a user, an image code output method, and a computer program.

### Solution to Problem

An image processing device system according to an aspect of the present disclosure includes: an image processing device; and a portable terminal, wherein the image processing device includes an outputter that outputs, to an external destination, operation settings information about operation settings configured through an operation by a user, an image code reader that reads an image code based on the operation settings information, an image code analyzer that analyzes the image code read by the image code reader and generates the operation settings information, and a configurator applying operation settings based on the operation settings information analyzed by the image code analyzer, and the portable terminal includes a terminal inputter to which the operation settings information output from the outputter is input, a terminal operation settings editor that edits the operation settings information input from the terminal inputter in accordance with an operation by the user to generate new operation settings information, a terminal image code generator that generates an image code based on the new operation settings information generated by the terminal operation settings editor, and a terminal image code outputter that outputs the image code generated by the terminal image code generator.

Accordingly, the user can transfer the operation settings information about the operation settings configured when using the image processing device to the portable terminal owned by the user, output the operation settings information as the image code when using the image processing device the next time, and cause the image processing device to read the image code to apply the operation settings. It is possible to edit the operation settings information transferred to the portable terminal, output the operation settings information as the image code in which contents of the operation settings are changed, and cause the image processing device to read the image code to apply the edited operation settings. Therefore, an operation burden of the image processing device on the user can be reduced. Since operation time can be shortened, the image processing device can be efficiently used.

In the image processing device system described above, the portable terminal may include a display that performs display related to the operation settings information to edit the operation settings information, and the operation settings information having settings different from standard setting values may be displayed in a print settings screen displayed on the display.

Accordingly, the user can easily recognize the settings different from the standard setting values when confirming the operation settings or editing the operation settings in the portable terminal to smoothly edit the operation settings.

In the image processing device system described above, the display may selectively display the print settings screen and a screen other than the print settings screen.

Accordingly, the user can easily confirm the necessary operation settings when confirming the operation settings or editing the operation settings to efficiently perform the work.

In the image processing device system described above, the display may display a standard settings operation inputter when the display displays the print settings screen, the standard settings operation inputter being operated by the user to collectively convert the display related to the operation settings information into having the standard setting values.

Accordingly, the user can easily and efficiently edit the operation settings.

In the image processing device system described above, the portable terminal may include a storage that stores the operation settings information, and after the standard settings operation inputter is operated by the user to collectively convert the display of the operation settings information into having the standard setting values, the display may display an original settings operation inputter, the former settings operation inputter being operated by the user to revert the displayed standard setting values to the display related to the operation settings information before the conversion.

Accordingly, the user can easily and efficiently edit the operation settings. After the operation settings are edited, the setting values can also easily be changed to the original setting values, and the editing work can be more easily performed.

In the image processing device system described above, the portable terminal may include a display that performs display related to the operation settings information to edit the operation settings information, and the display may display a user fee for the image processing device and display a payment selection operation inputter for a user to select a payment method.

Accordingly, the user can recognize the user fee when using the image processing device, which is highly convenient. A payment method can be easily set, which is highly convenient.

In the image processing device system described above, a plurality of the image processing devices may be included, and the image code reader of each of the image processing devices may be capable of reading the image code output from the terminal image code outputter.

Accordingly, the user can easily apply the operation settings to any of the image processing devices installed in a plurality of other places, which is highly convenient.

In the image processing device system described above, the portable terminal may include a storage that stores a plurality of pieces of the operation settings information different from each other.

Accordingly, the user can easily apply a plurality of operation settings to the image processing device. Operation settings similar to the contents of the desired operation settings among the plurality of operation settings can be selected to edit the operation settings, so the operation settings can be efficiently edited to improve working efficiency.

In the image processing device system described above, the image code may be a QR code (trade name).

Accordingly, the operation settings can be applied by using the QR code. The QR code enables exchange of information with few errors and includes a large amount of information even in a small area, and thus is highly convenient for the user.

An image code output method according to an aspect of the present disclosure is an image code output method for reading an image code and outputting the image code to be read by an image processing device that analyzes the image code, the image code output method including: executing, by a computer, processing of editing operation settings information input from an external source, and generating new operation settings information in accordance with an operation by a user; executing, by the computer, processing of generating the image code based on the new operation settings information; and executing, by the computer, processing of outputting the generated image code.

Accordingly, the user can easily generate and output the image code to be read by the image processing device, and can easily apply the operation settings to the image processing device by causing the image processing device to read the image code. Therefore, the working efficiency of the user is improved.

A computer program according to an aspect of the present disclosure is a computer program for use in a computer that reads an image code and outputs the image code to be read by an image processing device that analyzes the image code, the computer program causing a computer to execute: processing of editing operation settings information input from an external source, and generating new operation settings information in accordance with an operation by a user; processing of generating the image code based on the new operation settings information; and processing of outputting the image code.

Accordingly, the user can easily generate and output the image code to be read by the image processing device, and can easily apply the operation settings to the image processing device by causing the image processing device to read the image code. Therefore, the working efficiency of the user is improved.

### Advantage Effects of Invention

According to the present disclosure, it is possible to provide an image processing device system capable of reducing an operation burden on a user, an image code output method, and a computer program.

### BRIEF DESCRIPTION OF DRAWINGS

FIG. 1 is a schematic diagram illustrating a configuration of an image forming device system according to a first embodiment of the present disclosure.

FIG. 2 is a perspective view illustrating an external schematic configuration of an image forming device included in the image forming device system according to the first embodiment of the present disclosure.

FIG. 3 is a block diagram schematically illustrating a control configuration in the image forming device illustrated in FIG. 2.

FIG. 4 is a block diagram schematically illustrating a control configuration in a smartphone included in the image forming device system according to the first embodiment of the present disclosure.

FIG. 5 is a plan view illustrating a state in which a print settings screen is displayed on a display unit of the smartphone according to the first embodiment of the present disclosure.

FIG. 6 is a diagram illustrating a first aspect of the print settings screen displayed on the display unit of the smartphone according to the first embodiment of the present disclosure.

FIG. 7 is a diagram illustrating a second aspect of the print settings screen displayed on the display unit of the smartphone according to the first embodiment of the present disclosure.

FIG. 8 is a diagram illustrating an other settings screen displayed on the display unit of the smartphone according to the first embodiment of the present disclosure.

FIG. 9 is a diagram illustrating a stored operation settings list screen displayed on the display unit of the smartphone according to the first embodiment of the present disclosure.

FIG. 10 is a plan view illustrating a state in which a generated QR code is displayed on the display unit of the smartphone according to the first embodiment of the present disclosure.

FIG. 11 is a flowchart illustrating an example of a control operation in the image forming device included in the image forming device system according to the first embodiment of the present disclosure.

FIG. 12 is a flowchart illustrating an example of a control operation in the smartphone included in the image forming device system according to the first embodiment of the present disclosure.

FIG. 13 is a flowchart illustrating an example of a control operation when the image forming device reads a QR code included in the image forming device system according to the first embodiment of the present disclosure.

FIG. 14 is a block diagram schematically illustrating a control configuration in an image forming device included in an image forming device system according to a second embodiment of the present disclosure.

FIG. 15 is a block diagram schematically illustrating a control configuration of a smartphone included in the image forming device system according to the second embodiment of the present disclosure.

### DESCRIPTION OF EMBODIMENTS

Embodiments according to the present disclosure will be described below with reference to the drawings.

### First Embodiment

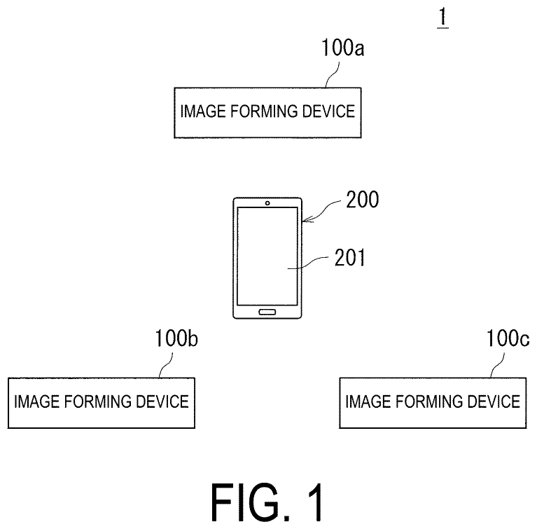

FIG. 1 is a schematic diagram illustrating a configuration of an image forming device system according to a first embodiment of the present disclosure.

As illustrated in FIG. 1, an image forming device system 1 that is an image processing device system includes an image forming device 100a that is an image processing device, an image forming device 100b that is an image processing device, an image forming device 100c that is an image processing device, and a smartphone 200. The image forming devices 100a to 100c will be described in detail below, but have similar functions. The image forming devices 100a to 100c are installed in, for example, a convenience store. The image forming devices 100a to 100c may be installed at different locations. In the first embodiment, the image forming device system 1 includes the three image forming devices 100a to 100c, but the image forming devices may be installed in each shop of a convenience store chain, and the number of the devices is not limited to three.

The smartphone 200 will be described in detail below, but the smartphone 200 can display an image on a display unit 201. Note that instead of the smartphone 200, a portable device such as a mobile phone, a digital camera, a tablet, or a notebook computer may be used. To be specific, it is sufficient that data transmission and reception can be performed with the image forming devices 100a to 100c, and a display unit capable of displaying image code is included.

In the image forming device system 1 according to the first embodiment, the image forming devices 100a to 100c can transfer, to the smartphone 200, operation settings as operation settings information that is data, the operation settings being performed by a user when using the image forming devices 100a to 100c.

The user can recognize the operation settings performed when using the image forming devices 100a to 100c from the operation settings information input to the smartphone 200. These operation settings are converted into a QR code to be read by the image forming devices 100a to 100c so that the same operation settings as used previously are applied to the image forming devices 100a to 100c.

The user can recognize the operation settings configured when using the image forming devices 100a to 100c from the operation settings information input to the smartphone 200, and can further edit these operation settings. The new edited operation settings are converted into a QR code to be read by the image forming devices 100a to 100c so that different operation settings than used previously are applied.

Here, the operation settings are settings contents configured by the user that are related to the operation of the image forming devices 100a to 100c, and include in copy processing, for example, selection of color copy or monochromatic copy, selection of paper size, whether enlargement/reduction is necessary, and the number of copies.

In this way, the user can easily input the operation settings to the image forming devices 100a to 100c without operating the image forming devices 100a to 100c to configure the operation settings. This can simplify the work of the user to operate the image forming devices 100a to 100c and shorten the operation time of the image forming devices 100a to 100c. Accordingly, the user can easily use the image forming devices 100a to 100c. Since the time to operate the image forming devices 100a to 100c can be shortened, the image forming devices 100a to 100c can be efficiently used, improving the operation efficiency of the image forming devices 100a to 100c. For example, it is more likely to reduce the waiting time for using the image forming devices 100a to 100c.

Note that also in a case where the user uses not the previously used image forming device (for example, the image forming device 100a) but another image forming device (for example, the image forming device 100b or 100c), the same operation settings as used previously are applied by causing the other image forming device to read the QR code using the smartphone 200. Note that instead of the QR code, an image code other than the QR code may be used.

The user can recognize the contents of the operation settings based on the operation settings information stored on the smartphone 200. As described above, these operation settings can be edited, and then the contents of the new edited operation settings can be converted into a QR code. By displaying the QR code based on the edited operation settings on the smartphone 200 and causing the QR code to be read by any one of the image forming devices 100a to 100c (for example, the image forming device 100a), the new edited operation settings are applied to the image forming device 100a. Accordingly, even in a case where the user uses the image forming device 100a with operation settings having new contents that are different from the previous time, the user can easily operate the image forming device 100a by generating the QR code in advance using the smartphone 200, reducing the burden on the user when operating the image forming device 100a. Note that the image forming devices 100b and 100c can also be caused to read the QR code, and in this case, the edited operation settings are applied to the image forming devices 100b and 100c by causing the image forming devices 100b and 100c to read the QR code.

Note that since the smartphone 200 also stores the operation settings information related to the operation settings before being edited, which are the contents for the image forming device 100a as previously operated, the contents of the same operation settings as used previously can also be converted into a QR code using the smartphone 200. The same or similar operation settings as used previously can easily be applied by causing the image forming device 100a to read this QR code. Similarly, the same or similar settings as the previous operation settings can also easily be applied to the image forming devices 100b and 100c by causing the image forming devices 100b and 100c to read this QR code.

The image forming devices 100a to 100c and the smartphone 200 will be described with reference to the drawings. Note that since the image forming devices 100a to 100c have the same configuration, only the image forming device 100a will be described below, and description of the image forming devices 100b and 100c will be omitted.

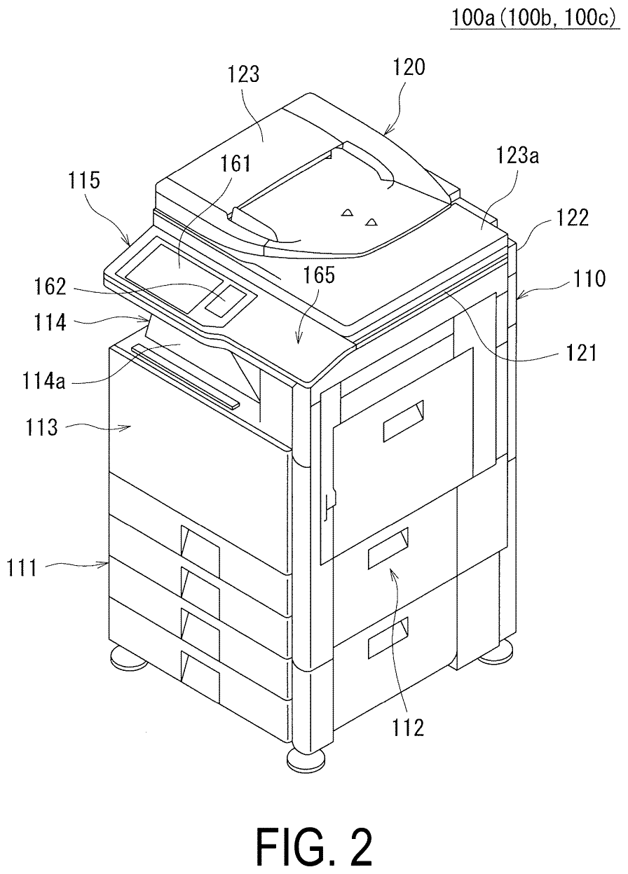

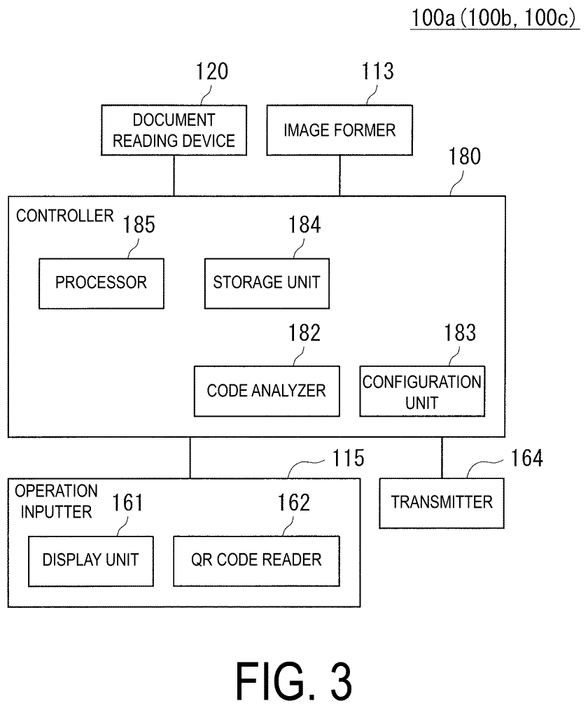

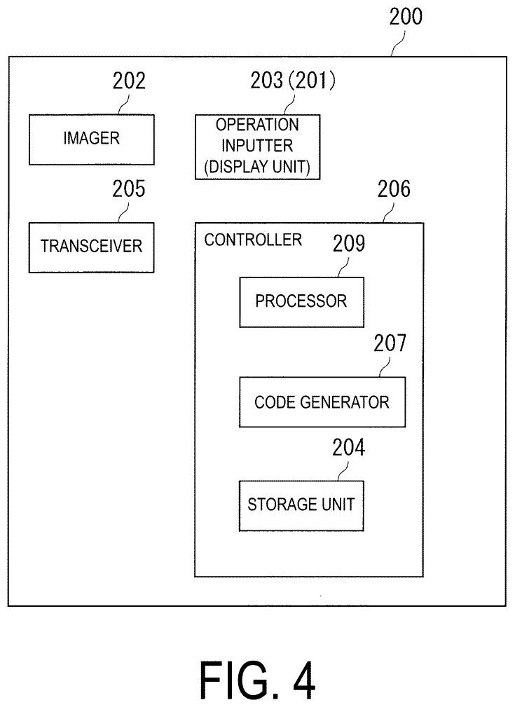

FIG. 2 is a perspective view illustrating an external schematic configuration of the image forming device included in the image forming device system according to the first embodiment of the present disclosure. FIG. 3 is a block diagram schematically illustrating a control configuration in the image forming device illustrated in FIG. 2. FIG. 4 is a block diagram schematically illustrating a control configuration in the smartphone included in the image forming device system according to the first embodiment of the present disclosure.

As illustrated in FIG. 2, the image forming device 100a includes an image forming device main body 110 and a document reading device 120.

The document reading device 120 is provided at an upper portion of the image forming device main body 110, and includes a document placement platform 121, a document reader 122, and an automatic document feeder 123. The document reading device 120 reads an image of a document placed on the document placement platform 121 with the document reader 122 or reads an image of a document automatically fed by the automatic document feeder 123 with the document reader 122, and transmits image data of the read document to the image forming device main body 110. The document reading device 120 discharges the document conveyed by the automatic document feeder 123 and read by the document reader 122 to a document discharge tray 123a.

The image forming device main body 110 includes a sheet accommodator 111, a sheet conveyor 112, an image former 113, a sheet discharger 114, and an operation inputter 115. The image forming device main body 110 accommodates recording sheets such as recording paper in the sheet accommodator 111, conveys a recording sheet accommodated in the sheet accommodator 111 with the sheet conveyor 112, forms a color image or a monochrome image on the recording sheet conveyed by the sheet conveyor 112 with the image former 113 based on the image data transmitted from the document reading device 120 or an external source, and discharges the recording sheet on which the image is formed with the image former 113 to a sheet discharge tray 114a in the sheet discharger 114.

The operation inputter 115 includes a display unit 161 and a QR code reader 162, and is provided with an operation member 165. Note that the display unit 161 is a touch panel display, which not only displays an image associated with an operation but also enables input by touching a screen of the display unit 161. The QR code reader 162 reads a QR code. Specifically, the QR code displayed on the display unit 201 of the smartphone 200 is held over the QR code reader 162 to read the QR code.

Here, a basic flow in a case will be described where the user uses the image forming device 100a. First, the user operates the operation inputter 115 to select which task is to be performed among copying, printing, faxing, scanning, and the like. For example, in a case where copying is selected, selection of paper size, whether enlargement/reduction is necessary, selection of double-sided or single-sided printing, density, the number of copies, selection of color copy or monochromatic copy, and the like are sequentially set following a guide displayed on the display unit 161. Then, copy processing is performed and the copy processing is completed (job completion).

As illustrated in FIG. 3, the image forming device 100a further includes a controller 180 that is responsible for the entire control of the image forming device 100a. As described above, the image forming device 100a has functions such as copying, printing, faxing, and scanning. The controller 180 is responsible for the operation of these functions, and also controls the operation of the document reading device 120 and the image former 113.

The controller 180 includes a code analyzer 182, a configuration unit 183, a storage unit 184, a processor 185, and a transmitter 164.

The controller 180 includes, for example, a microcomputer such as a central processor unit (CPU), and the storage unit 184 which is a storage device such as a read only memory (ROM), a random access memory (RAM), or a data rewritable nonvolatile memory.

The processor 185 loads and executes a control program stored in advance in the ROM of the storage unit 184 onto the RAM of the storage unit 184, thereby performing operation control of various components. The RAM of the storage unit 184 provides the processor 185 with a work area and an area serving as an image memory for storing image data.

The storage unit 184 also stores operation settings information which is data of operation settings configured by the user when using the image forming device 100a. Here, the operation settings have contents related to an operation performed by the user, and include in the copy processing, for example selection of paper size, whether enlargement/reduction is necessary, selection of double-sided or single-sided printing, density, the number of copies, and selection of color copy or monochromatic copy.

The code analyzer 182 analyzes a QR code read by the QR code reader 162 and generates operation settings information included in the QR code. Here, QR code analysis is performed based on a prescribed generation rule for the QR code. Note that since the image forming devices 100a to 100c in the image forming device system 1 perform analysis and the like based on the same generation rule, the same analysis is performed in any of the image forming devices 100a to 100c.

The configuration unit 183 stores the operation settings information generated by the code analyzer 182 in the storage unit 184, and applies operation settings based on the operation settings information when using the image forming device 100a.

The transmitter 164 transmits data to an external device via a network. To be specific, the image forming device 100a, which can communicate with the smartphone 200 using Wi-Fi or the like, performs data transmission and reception to and from the smartphone 200 via the transmitter 164. Note that the transmitter 164 may be capable of transmitting data to the smartphone 200 through infrared light or may be capable of transmitting data to the smartphone 200 through other means.

As illustrated in FIG. 4, the smartphone 200 includes an imager 202, an operation inputter 203 (the display unit 201), a storage unit 204, a transceiver 205, and a controller 206.

The imager 202, which images a subject, includes a camera.

The operation inputter 203 is an operation button or the like for the user to operate the smartphone 200. Note that the display unit 201 is a touch panel display, and that the user can input an operation by touching the display unit 201. Therefore, the operation inputter 203 also includes the display unit 201. The details will be described below, but the user can operate the operation inputter 203 to edit the operation settings of the operation settings information transmitted from the image forming device 100a. An operation can also be performed to display, on the display unit 201, a QR code based on the new edited operation settings. Other operations of the smartphone 200 can also be performed through the operation inputter 203.

The transceiver 205 communicates with an external device via a network. For example, communication with the image forming device 100a may be enabled via Wi-Fi or the like. Note that the transceiver 205 may be capable of communicating with the image forming device 100a through infrared rays, or may be capable of communicating with the image forming device 100a through other communication means.

The controller 206, which comprehensively controls the entire operation of the smartphone 200 and makes various determinations, is responsible for the entire control of the smartphone 200. The controller 206 includes a processor 209, a code generator 207, and a storage unit 204.

The controller 206 includes, for example, a microcomputer such as a central processing unit (CPU), and the storage unit 204 which is a storage device such as a read only memory (ROM), a random access memory (RAM), or a data rewritable nonvolatile memory.

The processor 209 loads and executes a control program or application soft (hereinafter, referred to as an app) stored in advance in the ROM of the storage unit 204 onto the RAM of the storage unit 204, thereby performing operation control of various components. The RAM of the storage unit 204 provides the processor 209 with a work area for performing tasks and an area serving as a memory for storing data such as image data.

In a case where the user operates the operation inputter 203 to edit the operation settings, the processor 209 edits the operation settings information transferred from the image forming device 100a based on the edited operation settings to generate new operation settings information. Note that also in this case, the original operation settings information transferred from the image forming device 100a is not deleted.

The storage unit 204 also stores the operation settings information and the like transferred from the image forming device 100a. The storage unit 204 also stores the new operation settings information generated by the processor 209.

In a case where the user operates the operation inputter 203 to instruct QR coding of the operation settings information, the code generator 207 generates a QR code based on the operation settings information stored in the storage unit 204. The generated QR code is displayed on the display unit 201.

The generation of the QR code by the code generator 207 is performed according to the generation rule described above. Accordingly, even in a case where the QR code generated by the code generator 207 is read by any of the image forming devices 100a to 100c, the same operation settings are applied.

Here, an example of a use case of the image forming device system 1 by a user will be described. The user operates the operation inputter 115 of the image forming device 100a to configure desired job settings. For example, double-sided copying with a paper size of B5 at 80% reduction is performed. Upon executing the job and completing the copy processing, the user operates the operation inputter 115 to transmit the operation settings information related to the executed operation settings to the smartphone 200 owned by the user. To be more specific, the contents of the operation settings are performing copying with “paper size: B5,” “enlargement/reduction: 80%,” and “double-sided copy”.

Note that the user can receive the operation settings information from the image forming device 100a by activating an app for receiving the operation settings information on the smartphone 200. Note that this app is also used for editing the operation settings and generating the QR code on the smartphone 200. The user stores the received operation settings information on the smartphone 200. The user, when performing the copy processing the next time, activates the app described above, brings up the previous operation settings, changes the contents of the operation settings if necessary, converts the operation settings into a QR code corresponding to the operation settings, and displays the QR code on the display unit 201. Further, the user operates the operation inputter 165 of the image forming device 100a to cause the QR code reader 162 of the image forming device 100a to read the QR code, thereby applying the operation settings to the image forming device 100a. The user confirms whether the contents of the operation settings are correct through the display on the display unit 161 and then executes the contents of the operation settings, thereby executing the copy processing (job) having the desired operation settings. In other words, double-sided copying with a paper size of B5 at 80% reduction is performed if the operation settings have not been changed, using the smartphone 200. For example, in a case where the operation settings have been edited so that copy processing with no reduction or 100% scaling is executed, double-sided copying with a paper size of B5 at the same size is performed. This makes it possible to reduce the task of operating the operation inputter 165, facilitate the operation, and shorten the operation time.

Further, an example of a screen displayed on the display unit 201 of the smartphone 200 and an example of the operation of the smartphone 200 when using the image forming device system 1 will be described with reference to the drawings.

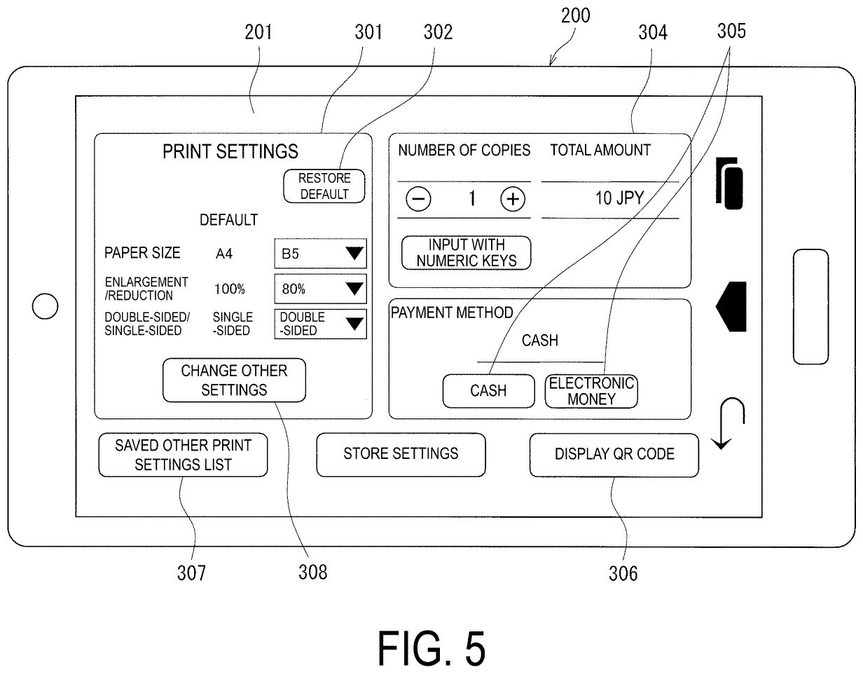

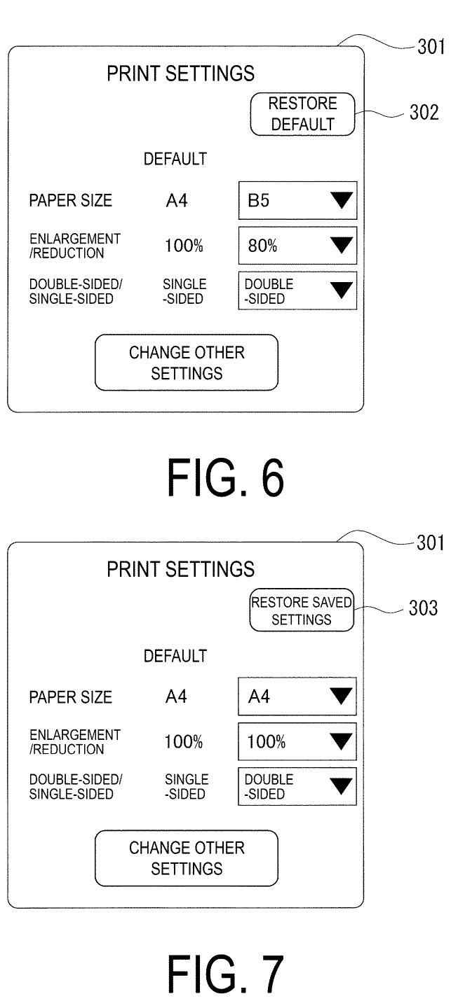

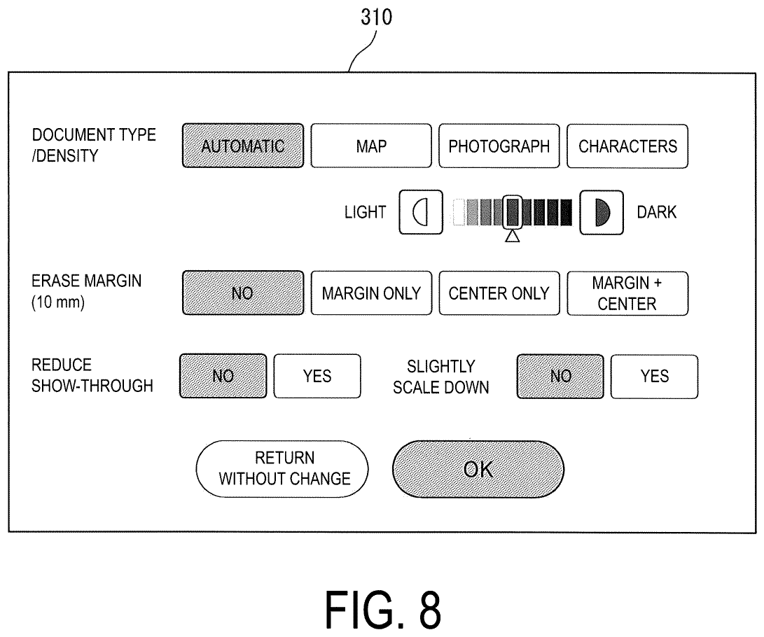

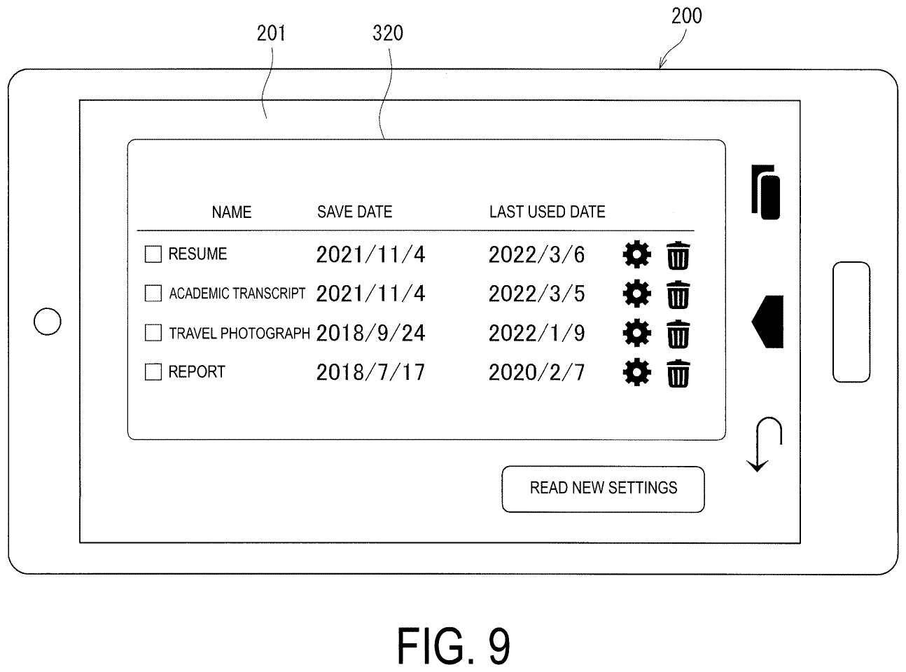

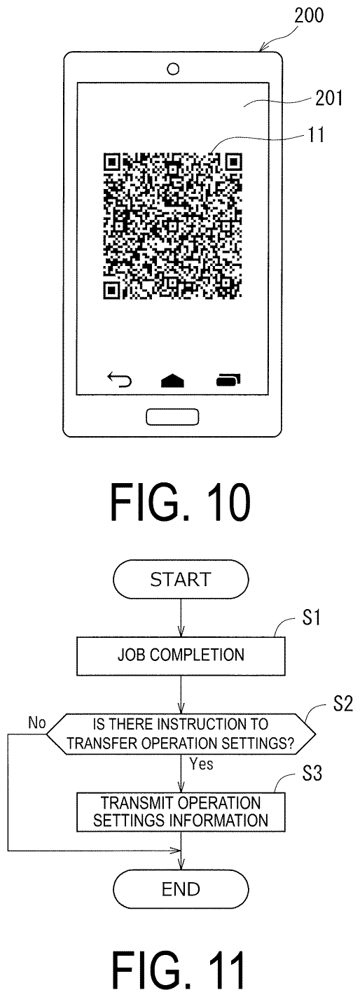

FIG. 5 is a plan view illustrating a state in which a print settings screen is displayed on the display unit of the smartphone according to the first embodiment of the present disclosure. FIG. 6 is a diagram illustrating a first aspect of the print settings screen displayed on the display unit of the smartphone according to the first embodiment of the present disclosure. FIG. 7 is a diagram illustrating a second aspect of the print settings screen displayed on the display unit of the smartphone according to the first embodiment of the present disclosure. FIG. 8 is a diagram illustrating an other settings screen displayed on the display unit of the smartphone according to the first embodiment of the present disclosure. FIG. 9 is a diagram illustrating a stored operation settings list screen displayed on the display unit of the smartphone according to the first embodiment of the present disclosure. FIG. 10 is a plan view illustrating a state in which a generated QR code is displayed on the display unit of the smartphone according to the first embodiment of the present disclosure.

The operation settings information is transmitted from the transmitter 164 of the image forming device 100a, and the transceiver 205 of the smartphone 200 receives the operation settings information and stores the operation settings information in the storage unit 204. When the user intends to use the image forming device 100a, the user activates the app described above on the smartphone 200 and operates the operation inputter 203 to display on the display unit 201 the operation settings of the operation settings information stored in the storage unit 204.

As illustrated in FIG. 5, a display screens related to the operation settings is displayed on the display unit 201. Specifically, a print settings screen 301, a fee display 304, payment selection keys 305, a QR code display key 306, a list display key 307, and the like are displayed on the display unit 201. The print settings screen 301 also includes a default key 302 and a change settings key 308.

The print settings screen 301 includes settings contents related to printing. To be more specific, operation settings for performing double-sided copying with a paper size of B5 at 80% reduction is illustrated. These operation settings are the operation settings applied by the user when previously using the image forming device 100a, and are transferred to the smartphone 200. In particular, on the print settings screen 301, only the items of the operation settings configured to be different from standard setting values may be displayed. Note that all of the operation settings including the items configured to the standard setting values may be displayed, settings with different values than the standard setting values may be emphasized when displaying all of the operation settings. In a case where all of the operation settings have the standard setting values, the items of the operation settings frequently changed such as “paper size,” “color,” and “double-sided/single-sided” may be displayed.

Here, the standard setting values are setting values initially set when configuring the operation settings of the image forming device 100a. In other words, the standard setting values are the default settings applied if the operation settings are not selected in a case where the user performs the copy processing using the image forming device 100a.

On the print settings screen 301, the standard setting values are indicated as “default” in the vicinity of the operation settings applied by the user. To be more specific, “paper size” is “A4”, “enlargement/reduction” is “100%”, and “double-sided/single-sided” is “single-sided”. This allows the user to recognize the standard setting values.

In the print settings screen 301 the items of the operation settings “paper size,” “enlargement/reduction,” and “double-sided/single-sided” can be changed from the current settings through an operation by the user. For example, other setting values may be selected by pulling down each item of the displayed operation settings. In this way, the user can edit the operation settings stored in the storage unit 204 to create new operation settings.

The default key 302 included in the print settings screen 301 can be selected (tapped) by the user to collectively change the items of the operation settings in the print settings screen 301 “paper size,” “enlargement/reduction,” and “double-sided/single-sided” to the standard setting values. Specifically, the default key 302 in the print settings screen 301 illustrated in FIG. 6 is selected to change the display to the print settings screen 301 illustrated in FIG. 7. This allows the operation settings to be collectively changed (edited) to have the standard setting values. Note that a revert key 303 included in the print settings screen 301 illustrated in FIG. 7 can be tapped to easily revert the display to the print settings screen 301 illustrated in FIG. 6.

Note that the change settings key 308 included in the print settings screen 301 is selected by the user to display an other settings screen 310 illustrated in FIG. 8 on the display unit 201. The other settings screen 310 displays operation settings that are not displayed in the print settings screen 301. The user can operate the display unit 201 (the operation inputter 203) on which the other settings screen 310 is displayed to also change items of the operation settings not included in the print settings screen 301.

As illustrated in FIG. 5, the fee display 304 is displayed on the display unit 201. The fee display 304 displays a fee (user fee) to be paid by the user in a case where the copy processing is executed using the image forming device 100a in accordance with the operation settings currently applied using the smartphone 200. The payment selection keys 305 are illustrated on the display unit 201. The payment selection keys 305 include “cash” and “electronic money”, and the user may select one corresponding to a preferred payment method. This allows the payment method of the fee to be set.

The list display key 307 displayed on the display unit 201 as illustrated in FIG. 5 is selected by the user to display a saved operation settings list screen 320 indicating other operation settings stored in the storage unit 204 of the smartphone 200 on the display unit 201 as illustrated in FIG. 9. The storage unit 204 can store a plurality of operation settings. In a case where the user, when using the image forming device 100a, applies operation settings that have not been used before, the user can transfer and store the operation settings information related to these operation settings to and in the smartphone 200. Also in a case where the operation settings are edited and changed to new operation settings, the storage unit 204 stores the operation settings both before and after being changed. The saved operation settings list screen 320 illustrates information related to each item of the operation settings stored in the storage unit 204, and also illustrates for each item a save date, a last used date on the image forming device 100a, and the like for each item. Each item of the operation settings can be named using the operation inputter 203 so that the contents of each item of the operation settings can be easily inferred (recognized). The user may select an item of the operation settings the user wishes to use from the saved operation settings list screen 320 displayed on the display unit 201.

As described above, after the user selects, or selects and edits, the operation settings the user wishes to use, the user may select the QR code display key 306 displayed on the display unit 201 illustrated in FIG. 5 in a case of applying these operation settings to the image forming device 100a. Accordingly, a QR code 11 corresponding to the operation settings is generated by the code generator 207, and the QR code 11 is displayed on the display unit 201 as illustrated in FIG. 10.

In a case where the user holds the display unit 201 over the QR code reader 162 of the image forming device 100a, the QR code reader 162 reads the QR code 11, and the code analyzer 182 analyzes the QR code 11 to generate the operation settings information included in the QR code 11. The operation settings information is stored in the storage unit 184, and the configuration unit 183 applies the operation settings based on the operation settings information. The copy processing according to the desired operation settings is performed by the image forming device 100a due to the user operating the operation inputter 115 to perform the copy processing.

Next, an example of the operation of the image forming device 100a and the smartphone 200 will be described with reference to the drawings.

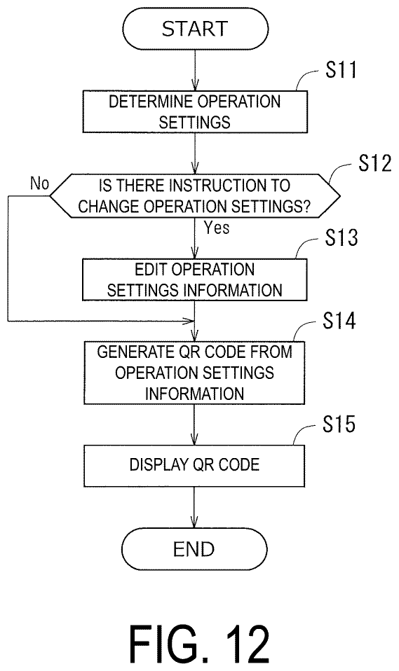

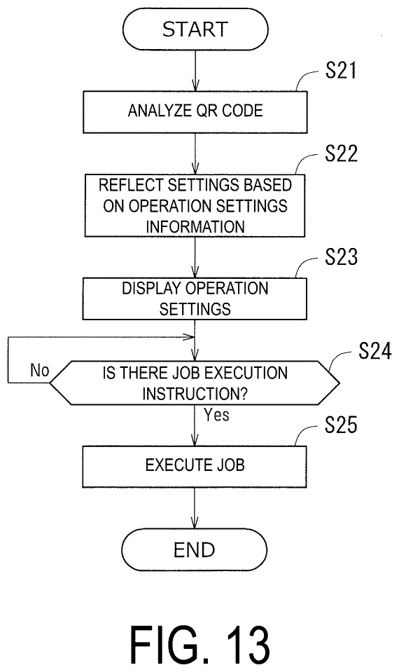

FIG. 11 is a flowchart illustrating an example of a control operation in the image forming device included in the image forming device system according to the first embodiment of the present disclosure. FIG. 12 is a flowchart illustrating an example of a control operation in the smartphone included in the image forming device system according to the first embodiment of the present disclosure. FIG. 13 is a flowchart illustrating an example of a control operation when the image forming device reads a QR code included in the image forming device system according to the first embodiment of the present disclosure.

First, the control operation of the image forming device 100a will be described. When the user executes the copy processing or the like using the image forming device 100a, as illustrated in FIG. 11, the operation settings information of the operation settings is stored in the storage unit 184 in the image forming device 100a. Upon completing the copy processing (job) (step S1), it is determined whether there is an instruction to transfer the operation settings information to the smartphone 200 (step S2). In a case where there is no instruction to transfer the operation settings information (step S2: No), the process is ended. In a case where there is an instruction to transfer the operation settings information (step S2: Yes), the transmitter 164 transmits the operation settings information stored in the storage unit 184 to the smartphone 200 (step S3), and the process ends.

Next, the control operation of the smartphone 200 will be described. The user selects appropriate operation settings from the operation settings stored in the smartphone 200. Thus, as illustrated in FIG. 12, the operation settings are determined (step S11). It is determined whether there is an instruction to edit the operation settings, and in a case where there is an instruction to edit the operation settings (step S12: Yes), editing of the operation settings information is executed by the processor 209 (step S13). Upon completing the editing of the operation settings information, the code generator 207 generates the QR code 11 based on the new edited operation settings information (step S14). In step S12, in a case where there is no instruction to edit the operation settings (step S12: No), the process proceeds to step S14.

Upon generating the QR code 11, the display unit 201 displays the QR code 11 (step S15), and the process ends.

Next, the control operation of the image forming device 100a after the QR code 11 displayed on the display unit 201 of the smartphone 200 is read by the QR code reader 162 will be described. As illustrated in FIG. 13, the code analyzer 182 analyzes the QR code 11 read by the QR code reader 162 and generates operation settings information included in the QR code 11 (step S21). Based on the generated operation settings information, the operation settings are reflected and applied by the configuration unit 183 (step S22). The display unit 161 displays the applied operation settings information (step S23). Note that at this time, the user changes the operation settings using the operation inputter 115 if necessary.

After step S23, it is determined whether there is a job (copy processing) execution instruction (step S24). In a case where there is no job execution instruction (step S24: No), the process returns to step S24 again. In a case where there is a job execution instruction (step S24: Yes), the job (copy processing) is executed (step S25), and the process ends.

The image forming device system 1 according to the first embodiment of the present disclosure has been described above. This makes it possible to reduce the operation burden on the user and to shorten the operation time of the image forming device 100a. Therefore, the user can easily operate the image forming device 100a, and the operation efficiency of the image forming device 100a is also improved.

Note that in the first embodiment, the operation settings information related to the operation settings edited using the smartphone 200 is converted into the QR code 11 in the smartphone 200 and read by the QR code reader 162, but the operation settings information may be transmitted to the image forming device 100a through a communication means using Wi-Fi, infrared, or the like.

The work by the image forming device 100a and the smartphone 200 may be performed by using a cloud.

### Second Embodiment

An image forming device system according to a second embodiment of the present disclosure is different from the image forming device system according to the first embodiment of the present disclosure in that the operation settings information is not transmitted from the image forming device to the smartphone 200, but the QR code based on the operation settings is displayed in the image forming device and the user uses the smartphone to capture and analyze the QR code to generate the operation settings information. All other elements are the same as the image forming device system according to the first embodiment of the present disclosure.

In the following description of the image forming device system according to the second embodiment of the present disclosure, description of the same elements as those in the first embodiment will be omitted. In the drawings, like members are denoted by like reference numerals.

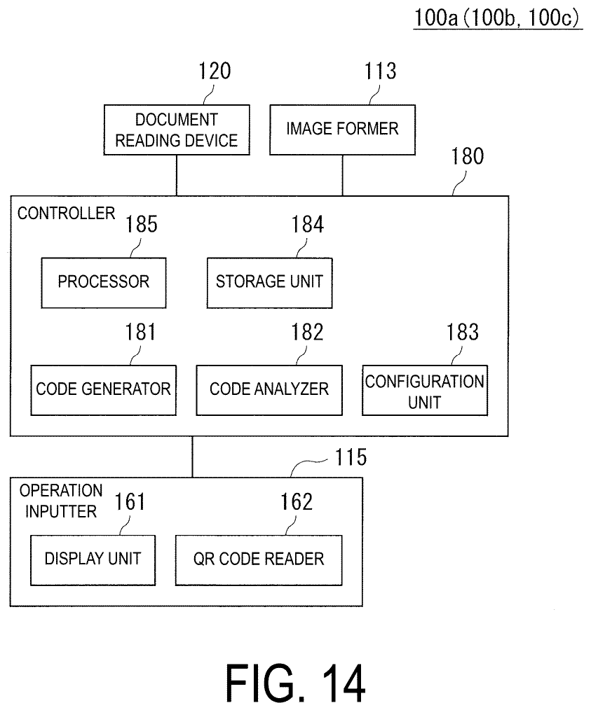

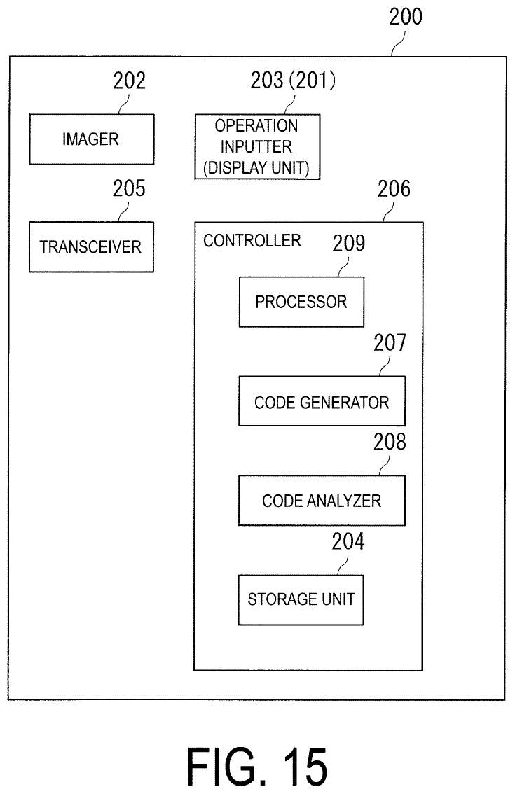

FIG. 14 is a block diagram schematically illustrating a control configuration in the image forming device included in the image forming device system according to the second embodiment of the present disclosure. FIG. 15 is a block diagram schematically illustrating a control configuration of the smartphone included in the image forming device system according to the second embodiment of the present disclosure.

As illustrated in FIG. 14, unlike the first embodiment, the image forming device 100a does not include the transmitter 164, and the controller 180 includes a code generator 181.

The code generator 181 generates a QR code based on the operation settings information. Note that the generation rule for generating the QR code 11 is the same as that for the code analyzer 182.

As illustrated in FIG. 15, in the smartphone 200, unlike the first embodiment, the controller 206 includes a code analyzer 208. Note that the smartphone 200 includes the imager 202 and has an imaging function. Data of the image captured by the imager 202 is stored in the storage unit 204. An image stored in the storage unit 204 can be displayed on the display unit 201.

The code analyzer 208 analyzes the QR code based on the image data of the QR code captured by the imager 202, and generates operation settings information included in the QR code. QR code analysis is performed based on the generation rule.

The user operates the operation inputter 115 to configure the operation setting when using the image forming device 100a, and operation settings information based on the operation settings is stored in the storage unit 184. In a case where the user operates the operation inputter 115 to instruct QR coding of the operation settings after completing a job such as copy processing in the image forming device 100a, the code generator 181 generates a QR code based on the operation settings information stored in the storage unit 184. The QR code generated by the code generator 181 is displayed by the display unit 161.

The user uses the imager 202 of the smartphone 200 to capture an image of the QR code displayed on the display unit 161. The image data of the QR code obtained through the capturing is stored in the storage unit 204.

The user can recognize contents of the operation settings based on the QR code stored in the smartphone 200, and can further edit the operation settings and convert the operation settings into a QR code including the contents of the new edited operation settings. By displaying the QR code based on the edited operation settings on the smartphone 200 and causing the QR rode to be read by any one of the image forming devices 100a to 100c (for example, the image forming device 100a), the edited operation settings are applied to the image forming device 100a. Accordingly, even in a case where the user uses the image forming device 100a with operation settings having new contents that are different from the previous time, the user can easily apply the operation settings of the image forming device 100a by generating the QR code in advance using the smartphone 200, reducing the burden on the user when operating the image forming device 100a. Note that the image forming devices 100b and 100c can also be caused to read the QR code including the edited operation settings, and in this case, the edited operation setting are applied to the image forming devices 100b and 100c by causing the image forming devices 100b and 100c to read the QR code.

Here, an example of a use case of the image forming device system 1 by the user will be described. The user operates the operation inputter 115 of the image forming device 100a to configure desired job settings. For example, double-sided copying with a paper size of B5 at 80% reduction is performed. Upon executing the job and completing the copy processing, the user operates the operation inputter 115 to instruct to generate the QR code 11 including the operation settings information related to the executed operation settings. As a result, for example, the QR code corresponding to the operation settings having the contents that the copy processing is performed with “paper size: B5,” “enlargement/reduction: 80%,” and “double-sided copy” is generated by the code generator 181 and displayed on the display unit 161.

The user uses the imager 202 of the smartphone 200 to capture an image of the QR code displayed on the display unit 161, and the storage unit 204 stores the QR code. The user activates an app capable of analyzing the QR code. The user operates the operation inputter 203 to cause the code analyzer 208 to analyze the QR code 11 to generate operation settings information, and the storage unit 204 stores the operation settings information. Note that the app can also be used for editing the operation settings and generating the QR code.

Subsequently, when using the image forming device 100a to perform the copy processing again, the user activates the app described above, brings up the previous operation settings, changes the contents of the operation settings if necessary, converts the operation settings into a QR code corresponding to the operation settings, and displays the QR code on the display unit 201. Further, the user operates the operation inputter 115 of the image forming device 100a to cause the QR code reader 162 of the image forming device 100a to read the QR code, thereby applying the operation settings to the image forming device 100a. The user confirms whether the contents of the operation settings are correct through the display on the display unit 161 and then executes the contents of the operation settings, thereby executing the copy processing (job) having the desired operation settings. In other words, double-sided copying with a paper size of B5 at 80% reduction is performed if the operation settings have not been changed, using the smartphone 200. For example, in a case where the operation settings have been edited so that copying with no reduction or 100% scaling is performed, double-sided copying with a paper size of B5 at the same size is performed. This makes it possible to reduce the task of operating the operation inputter 115, facilitate the operation, and shorten the operation time.

The image forming device system 1 according to the second embodiment of the present disclosure has been described above. This makes it possible to reduce the operation burden on the user and to shorten the operation time of the image forming device 100a. Therefore, the user can easily operate the image forming device 100a, and the operation efficiency of the image forming device 100a is also improved.

### Other Embodiments

Note that in the first and second embodiments, the operation settings information related to the operation settings edited using the smartphone 200 is converted into the QR code 11 in the smartphone 200 and read by the QR code reader 162, but the operation settings information may be transmitted to the image forming device 100a through a communication means using Wi-Fi, infrared rays, or the like.

The present disclosure is not limited to the embodiments described above and can be implemented in various other forms. Thus, the above embodiments are merely examples in all respects and should not be interpreted as limiting. The scope of the present disclosure is indicated by the claims and is not limited to the description. Furthermore, all modifications and changes equivalent in scope with the claims are included in the scope of the present disclosure.

### REFERENCE SIGNS LIST

1 Image forming device system (image processing device system)
11 QR code (image code)
100a, 100b, 100c Image forming device (image processing device)
110 Image forming device main body
111 Sheet accommodator
112 Sheet conveyor
113 Image former
114 Sheet discharger
114a Sheet discharge tray
115 Operation inputter
120 Document reading device
121 Document placement platform
122 Document reader
123 Automatic document feeder
123a Document discharge tray
161 Display unit (outputter)
162 QR code reader (image code reader)
164 Transmitter (outputter)
165 Operation member
180 Controller
181 Code generator (image code generator)
182 Code analyzer (image code analyzer)
183 Configuration unit (configurator)
184 Storage unit
185 Processor
200 Smartphone (portable terminal)
201 Display unit (display, terminal image code outputter)
202 Imager (terminal inputter)
203 Operation inputter (terminal operation settings editor, display)
204 Storage unit (storage)
205 Transceiver (terminal inputter)
206 Controller
207 Code generator (terminal image code generator)
208 Code analyzer (terminal image code analyzer)
209 Processor (terminal operation settings editor)
301 Print settings screen
302 Default key (standard settings operation inputter)
303 Revert key (original settings operation inputter)
304 Fee display
305 Payment selection key (payment selection operation inputter)
306 QR code display key
307 List display key
308 Change settings key
310 Other settings screen
320 Saved operation settings list screen

1. An image processing device system comprising:
an image processing device; and
a portable terminal,
wherein the image processing device includes
an outputter that outputs, to an external destination, operation settings information about operation settings configured through an operation by a user,
an image code reader that reads an image code based on the operation settings information,
an image code analyzer that analyzes the image code read by the image code reader and generates the operation settings information, and
a configurator that applies operation settings based on the operation settings information analyzed by the image code analyzer, and
the portable terminal includes
a terminal inputter to which the operation settings information output from the outputter is input,
a terminal operation settings editor that edits the operation settings information input from the terminal inputter in accordance with an operation by the user and generates a new instance of the operation settings information,
a terminal image code generator that generates an image code based on the new instance of the operation settings information generated by the terminal operation settings editor, and
a terminal image code outputter that outputs the image code generated by the terminal image code generator.

2. The image processing device system according to claim 1,
wherein the portable terminal includes a display that performs display related to the operation settings information to edit the operation settings information, and
the display displays, in a print settings screen, the operation settings information having settings different from standard setting values.

3. The image processing device system according to claim 2,
wherein the display selectively displays the print settings screen and a screen other than the print settings screen.

4. The image processing device system according to claim 2,
wherein the display displays, when the display displays the print settings screen, a standard settings operation inputter that collectively converts the display related to the operation settings information into having the standard setting values through an operation by the user.

5. The image processing device system according to claim 4,
wherein the portable terminal includes a storage that stores the operation settings information, and
the display displays, after collectively converting the display related to the operation settings information into having the standard setting values through the operation by the user, an original settings operation inputter that reverts the standard setting values displayed to the display related to the operation settings information before the conversion through an operation by the user.

6. The image processing device system according to claim 1,
wherein the portable terminal includes a display that performs display related to the operation settings information to edit the operation settings information, and
the display displays a user fee of the image processing device and displays a payment selection operation inputter for the user to select a payment method.

7. The image processing device system according to claim 1,
wherein a plurality of the image processing devices are included, and
the image code reader of each of the image processing devices is capable of reading the image code output from the terminal image code outputter.

8. The image processing device system according to claim 1,
wherein the portable terminal includes a storage that stores a plurality of pieces of the operation settings information different from each other.

9. The image processing device system according to claim 1,
wherein the image code is a QR code.

10. An image code output method for reading an image code and outputting the image code to be read by an image processing device that analyzes the image code, the image code output method comprising:
executing, by a computer, processing of editing operation settings information input from an external source and generating a new instance of the operation settings information in accordance with an operation by a user,
executing, by the computer, processing of generating the image code based on the new instance of the operation settings information, and
executing, by the computer, processing of outputting the image code generated.

11. A computer-readable non-transitory recording medium recording a program that reads an image code and outputs the image code to be read by an image processing device that analyzes the image code, the program causing a computer to execute:
processing of editing operation settings information input from an external source and generating a new instance of the operation settings information in accordance with an operation by a user;
processing of generating the image code based on the new instance of the operation settings information; and
processing of outputting the image code.
